(19) United States
(12) Patent Application Publication
(10) Pub. No.: US 2016/0062722 A1
(43) Pub. Date: Mar. 3, 2016

(54) MULTIPLE DISPLAY CONTROLLER SYSTEM

(71) Applicant: ProSports Technologies, LLC, Miami, FL (US)

(72) Inventors: John E. Cronin, Bonita Springs, FL (US); Seth Melvin Cronin, Milton, VT (US); Nick Reasner, Chicago, IL (US)

(21) Appl. No.: 14/837,457

(22) Filed: Aug. 27, 2015

Related U.S. Application Data
(60) Provisional application No. 62/045,253, filed on Sep. 3, 2014.

(51) Int. Cl. G06F 3/14; G06F 3/0481; G06F 9/445

(52) U.S. Cl. CPC G06F 3/1423; G06F 8/65; G06F 3/0481

(57) ABSTRACT

The systems and methods directed towards a centralized control system for managing multiple displays associated with one or more devices. A user is capable of controlling what types of information is displayed on one or more displays. A user may also customize and upgrade functionalities of the various displays through the implementation of upgrades (e.g., software applications) that can be downloaded and installed into the user device. The functionalities may be obtained from a central network.

### CROSS-REFERENCE TO RELATED APPLICATIONS

The present application claims the priority benefit of U.S. provisional application No. 62/045,253 filed Sep. 3, 2014 and entitled “Multiple Display Controller System,” the disclosure of which is incorporated herein by reference.

### BACKGROUND OF THE INVENTION

1. Field of Invention

The present invention generally relates to the display of images. More specifically, the present invention relates to coordinating display of multiple display devices.

2. Description of the Related Art

Users can display images using a variety of different methods. For example, presently people are capable of using light emitting diodes (LED) and liquid-crystal displays (LCDs) to display images of data provided from hand-held devices (e.g., smartphones). The images may be provided, for example, via Bluetooth communication between the display and the hand-held devices of the user. One or more displays may be incorporated into a variety of different mediums including clothing (e.g., hats, shirts, jackets, wrist watch) and various stationary objects (e.g., desks, refrigerators, cars). Users may possess a plurality of displays that each have a distinct usage or function.

Users may have a user device (e.g., smartphone) that can send and receive many types of digital data. The data may be received and transmitted through the use of the cloud or Internet. Functionalities associated with the user device can be improved or supplemented through, for example, the download of digital software applications. These digital software applications could be free or purchased from third parties for a pre-defined cost.

Since users may have a plurality of user devices (e.g., smartphone, GPS), users can have a corresponding plurality of different screens available. These screens can be associated with smartphones, GPS, digital picture frames and other displays found on corresponding user devices. In some cases, users may have displays on their clothing (e.g., hats, shirts).

The displays associated, for example, with the various user devices and clothing may be associated with a single functionality or may be associated with standalone software. These displays may also not be capable of being upgraded. There is a need for a centralized application or business model that allows users to coordinate and manage the plurality of displays that are within range of the user.

### SUMMARY OF THE CLAIMED INVENTION

A method for managing multiple displays associated with one or more electronic devices via a user device is claimed. The method includes downloading a display control application onto a user device. The method also includes registering one or more electronic devices via the display control application. The registered electronic devices each have one or more displays that will be managed via the user device. The method also includes transmitting display data corresponding to data that will be displayed on one or more electronic device displays to the user device. Afterwards, the user can view, select and download one or more upgrades to be used with one or more electronic device displays. The upgrades are associated with an upgrades marketplace. The user can then customize one or more electronic device display settings via the user device. Lastly, the method includes displaying the display data on the one or more electronic device displays based on the customized electronic device display settings provided by the user via the user device.

A system for managing multiple displays associated with one or more electronic devices via a user device is also claimed. The system includes a user device that includes a user interface used to manage the one or more electronic device displays, a database associated with an upgrades marketplace that includes one or more upgrades and a processor that executes instructions stored in memory. The processor executes instructions stored in memory to perform a number of steps that facilitates managing multiple displays. The processor downloads the display control application onto the user device that the user will utilize to manage the one or more electronic device displays. The processor also registers the one or more electronic devices that will be managed using the user device via the display control application. Display data, corresponding to data that will be displayed on one or more electronic device displays is then transmitted to the user device. The user is then provided one or more upgrades that can be viewed, selected and downloaded for use with the user device. The user can then customize display settings for one or more electronic device displays via the user device. The display data is then displayed on the one or more electronic device based on the customized display settings.

### BRIEF DESCRIPTION OF THE DRAWINGS

FIG. 1 illustrates a multiple display controller system for managing a plurality of displays.

FIG. 2 illustrates a method for the multiple display controller system.

FIG. 3 illustrates the device manager graphical user interface.

FIG. 4 illustrates the upgrades marketplace graphical user interface.

FIG. 5 illustrates further detailed graphical user interfaces of some exemplary upgrades included in the upgrades marketplace.

FIG. 6 illustrates a cellphone notification upgrade GUI.

FIG. 7 illustrates display control databases.

FIG. 8 illustrates a method for operating the multiple display device controller system.

### DETAILED DESCRIPTION

The systems and methods as described herein are directed towards a centralized control system for managing multiple displays associated with one or more devices. A user is capable of controlling what types of information is displayed on one or more displays. A user may also customize and upgrade functionalities of the various displays through the implementation of upgrades (e.g., software applications) that can be downloaded and installed into the user device. The functionalities may be obtained from a central network.

In an embodiment of the present invention, a user may be capable of controlling what is displayed on one or more displays owned by the user within a given range through the use of their user device (e.g., smartphone). Through the use of the smartphone, the user may also be capable of customizing and upgrading the functionalities of the various displays, for example, through the downloading of software applications. Additional functionalities may include adding geo-fencing functionalities, use of real-time network data, smartphone notifications, active wallpapers, camera roll (of images), slideshow (of images), syncing display with social media, search engine image results, adjusting display brightness, sleep timers, news, weather and webcam stream.

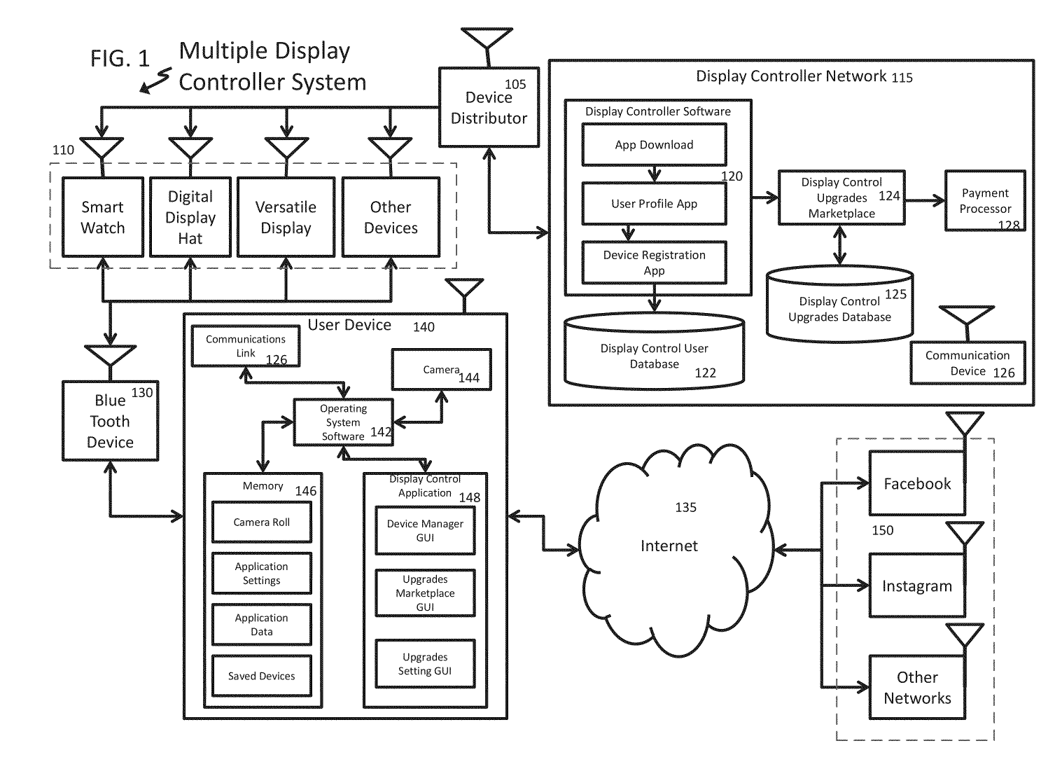

FIG. 1 illustrates a multiple display controller system 100 for managing a plurality of displays. The multiple display controller system 100 can control and manage the operation of the various displays 110 associated with multiple display controller system 100. The multiple display controller system 100 can also customize and upgrade functionalities associated with the various displays 110.

With reference to FIG. 1, the multiple display controller system 100 includes a device distributor 105. The device distributor 105 is associated with a distributor, for example, the electronic devices that are associated with the various displays that are managed by the multiple display controller system 100. Exemplary distributors that can be associated with the device distributor 105 may include retail companies including Wal-Mart or Best-Buy that sell or distribute the electronic devices. The device distributor 105 includes a communication module or link that facilitates transmission of information from the device distributor 105 to the various electronic devices having displays 110 sold or distributed by the distributor. The device distributor 105 may also be connected, via the communication module or link, with a display controller network 115. The display controller network 115 facilitates users with the customization and upgrade of functionalities associated with the various displays 110 alongside a user device 140 (e.g., smartphone). The device distributor 105 provides information (e.g., device registration) regarding the various electronic devices having displays 110 to the display controller network 115. Further details regarding the display controller network 115 will be provided below.

As noted above, the distributors (e.g., Wal-Mart) may sell or distribute a variety of different electronic devices having one or more displays 110. Exemplary electronic devices, as illustrated in FIG. 1, include smart watches, hats and versatile displays. While the smart watch and hat may include one versatile display, there may be items that include one or more electronic devices that are used to display information via one or more versatile displays. The displays associated with the electronic devices have the capability of receiving and transmitting audio and/or video information using wired or wireless communication. Exemplary communication methods may include Bluetooth. The audio and/or video information may be transmitted, for example, from a user device 140 (e.g., smart phone) described in further detail below. It should be noted that other electronic devices not currently listed or illustrated in FIG. 1 having displays may also be sold or distributed by the distributor. These displays may also be managed by the multiple display controller system 100 described herein.

The multiple display controller system 100 includes the display controller network 115. The display controller network 115 may be one or more processors with associated memory connected to the cloud or Internet 135 via the use of the communication module or link 126. Communication can be performed, for example, using wireless communication means known in the art (e.g., Wi-Fi, 3G, 4G, LTE, Bluetooth). In another embodiment, the display controller network 115 may be stored in the cloud or Internet 135. As described above, the display controller network 115 is capable of receiving information regarding various electronic devices having displays 110. Using the information about each of the electronic devices, the display controller network 115 can customize and upgrade functionalities of the electronic devices having displays 110.

The display controller network 115 includes display controller software 120. The display controller software 120 provides a way for users to customize and upgrade the functionalities of the electronic devices 110. The display control software 120 allows, for example, users to download a display controller application onto their user device 140 (e.g., smart phone) whereby the user can provide user input to customize and upgrade the functionality of the electronic devices 110. The display controller software 120 can also receive user profile information and device registration information. As noted above, the device registration information may be provided from the device distributor 105. Users may also be capable of providing device registration information as well as user profile information using their user device 140 (e.g., smart phone). The information received by the display controller software 120 (e.g., user profile, device registration) is stored into the display control user database 122. The information stored in the display control user database 122 may be stored for future use by the user. In some embodiments, third parties may access the information stored in the control user database 122. For example, third parties (e.g., service providers, retailers) may use the information in order to provide relevant information (e.g., updates, upgrades, deals) to the users regarding their corresponding electronic devices having displays 110.

The display controller network 115 can also utilize the communication link 126 to connect to user-related social media networks 150 (e.g., Facebook, Instagram). In this way, the display controller network 115 may obtain user-related information that can be provided to the display controller software 120 (i.e. user profile).

Alongside the display controller software 120, the display controller network 115 also includes a display control upgrades marketplace 124. The display control upgrades marketplace 124 provides a way for users to view, select and purchase various upgrades that can be applicable to the various electronic devices 110. The display controller software 120 facilitates connection between the user and the display control upgrades marketplace 124. Users, via the display control upgrades marketplace 124, can download one or more functionalities to be used with their electronic devices 110. The various functionalities may be stored in the display control upgrades database 125. When requested by the user, the display control upgrades marketplace 124 will obtain the chosen functionalities or upgrades from the database 125 so that the chosen functionality or upgrade can be downloaded by the user onto, for example, their user device 140 (e.g., smart phone).

In some embodiments, the functionalities (or upgrades) may require payment. If payment is required, the display controller software 120 may utilize the payment processor 128 to facilitate the payment process. In particular, the payment processor 128 may obtain user input regarding payment information (e.g., credit card information). Once payment information has been processed by the payment processor 128, the display controller software 120 may subsequently allow the user to download the chosen upgrade.

The multiple display controller system 100 includes a user device 140 that can be used by the user to manage the various electronic devices having displays 110. The various electronic devices 110 may be communicatively connected to the user device 140 using Bluetooth technology 130. Exemplary user devices 140 may include smart phones and tablets. The user devices 140 may also include a camera 144 and a corresponding operating system 142. The camera 144 may be used to obtain images that can subsequently be stored and displayed on one or more displays on the electronic devices 110. The operation system (OS) 142 may include instructions for handling basic system services and for performing hardware dependent tasks. Exemplary operating systems 142 may include Darwin, RTXC, LINUS, UNIX, OSX, ANDROID, WINDOWS, or an embedded operating system such as VXWorks.

The operating system 142 may be connected to the memory 146 of the user device 140. The memory 146 of the user device 140 may include information such as camera roll (that includes images obtained via the camera of the user device 140), application settings, application-based data, and saved device information associated with the user device 140.

The operating system 142 may also be connected to display control application 148. The display control application 148 facilitates device management via the device manager GUI. The device manager GUI allows the users to manage the electronic devices 110 that the user owns. The display control application 148 also facilitates the display, review, selection and download onto the user device 140 of the information from the upgrade market 124 (from the display controller network 115) via an upgrades marketplace GUI. Lastly, the display control application 148 includes an upgrades settings GUI that allows the user to manage the various upgrades associated with the various electronic devices having displays 110 owned and within range of the user.

With reference to FIG. 1, the user device 140 may be connected to the cloud or Internet 135. Although the figure only illustrates the user device 140 as being connected via a corresponding communication module/link 126 of the user device 140, other elements of the figure (e.g., the display controller network 115, the device distributor 105, the various electronic devices 110) may also be connected to the cloud or Internet 135. The cloud or Internet 135 may facilitate various communications between the elements of the multiple display controller system 100.

Through the cloud or Internet 135, the user device 140 may be connected to one or more social media networks 150 (e.g., Facebook, Instagram). The user may have one or more user accounts on the social media networks 150. As noted above, user-based information may be obtained from the social media networks 150. A particular user can provide access to the social media network-based information, for example, to their user device 140 or the display controller network 115 by providing related user information (e.g., account information, password). In this way, the display controller software 120 may be capable of providing relevant functionalities and upgrades that the user may be interested in.

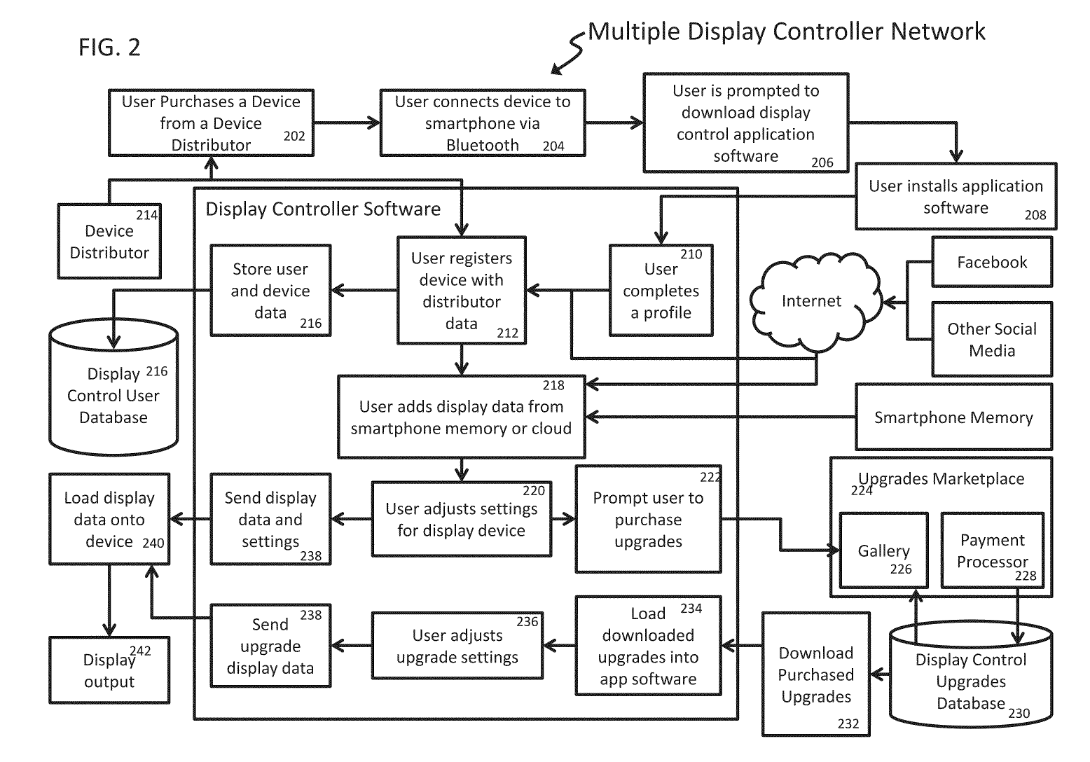

FIG. 2 illustrates a method for the multiple display controller system. As noted above, the display controller network is a centralized network that facilitates users with customization and upgrading various functionalities for the electronic devices having displays alongside a user device (e.g., smart phone) of the multiple display controller system. The figure illustrates the various steps involved in the method 200 that is undertaken by the display controller network and/or the user (and corresponding user device) directed at facilitating customization or upgrading of one or more electronic devices associated with the user device.

In step 202, a user purchases one or more electronic devices from a distributor. As noted above, the electronic devices can correspond to any type of electronic device that includes one or more displays (e.g., clothes, smart watch) subject to the multiple display controller system. These electronic devices can be sold or distributed from one or more distributors (e.g., Wal-mart, Best Buy).

As noted in the figure, the device distributor (via step 214) may begin providing electronic device-based information to the user or to the display controller software. The electronic device-based information may be provided to the user device once the user device has been identified and connected with the recently purchased electronic device. The electronic device-based information may also be provided to the display controller software of the display controller network. The device distributor (via step 212) may provide the information to the display controller software once the user registers the recently purchased electronic device with the display controller network.

In step 204, the user connects the recently purchased electronic device with user device. For example, the user device may be a smartphone that can connect to the electronic device through the use of a communication module/link (e.g., Bluetooth). The user device may include an application (and associated memory) that can store information about the recently purchased electronic device. The application (e.g., device manager GUI) may allow, for example, the user to view what devices can be controlled by the user device. The application can also provide information to the user as to what added functionalities or upgrades can be associated with one or more electronic devices. As noted above, once the electronic device is connected with the user device, the device distributor can also provide electronic device related information to the user device for use by the user.

In step 206, the user may be prompted to download related display control application software. The display control application may be an application that facilitates in the viewing, selection and download of functionalities and upgrades that may be provided via the control upgrade marketplace. The user may be prompted with instructions on where and how the requested display control application software is downloaded. The user, via the user device, can download the display control application software from the control application marketplace or a designated website.

In step 208, the user can install the downloaded display control application software downloaded in step 206. Once the display control application software is installed, the user (via the user device) can interact with the display controller software of the display controller network. For example, the display control application can facilitate in the display, selection and download of functionalities and upgrades from the upgrades marketplace.

It should be noted that steps 206 and 208 may be skipped if the user device already has the requested display control application installed on the user device. For example, after a first purchase of an electronic device, subsequent purchases of additional electronic devices may be connected to the user device but can use the installed application software already available. There may be some situations, however, where future purchases of an electronic device may require download and installation of updated or different display control application software. In these situations, the user can download and install the updated or different display control application software for use with the user device.

Once the application software has been installed (via step 208), the user can provide user related profile information to the display controller software in the display controller network via step 210. The user can provide the information, for example, through a graphical user interface (GUI) on the user device. The information can then be uploaded to the display controller software using, for example, the cloud or Internet. Alternatively, user profile information can be obtained from social media networks (e.g., Facebook).

As noted above, in step 212, the user can register the purchased electronic devices with the display controller software. Once connected, the device distributor can provide related electronic device information for use by the display controller software. The related information provided by the device distributor can be used to inform what types of functionalities and/or upgrades can be displayed for the user to view. For example, a set number of applications may be compatible for use with the recently purchases electronic device. The display controller software, using the information from the device distributor, can identify these applications and only provide these to the user. In other embodiments, an indicator can be provided alongside each available application in the control upgrade marketplace. The indicator can provide information to the user as to whether or not a particular functionality or upgrade is compatible with the particular electronic device.

In step 216, the information that has been provided by the user (via the user device) and the device distributor 214 may be stored into a display control user database. The display control user database may store the information regarding the user profile, corresponding electronic devices and user device into memory for future use. In some embodiments, third parties may also utilize the information to provide related information to the user (e.g., upgrades, news, deals).

In step 218, display data for one or more electronic devices are added. The display data may be provided to the display controller software, for example, by the user using their user device (e.g., smartphone). In another embodiment, display data may also be obtained from one or more social media networks (e.g., Facebook) via the cloud or Internet. Display data may include images that the user may want to display on one or more displays associated with the electronic devices. For example, the user device (e.g., smart phone) or user account on Facebook may include such images that would be provided to the display controller software.

In step 220, the user is provided an ability to adjust settings for one or more displays found on the electronic device(s). The settings are used to customize, for example, how the display data provided to the electronic device is shown on the display. The settings may be customized, for example, through a graphical user interface (GUI) displayed on the user device. The GUI may obtain user input regarding how the display settings should be set for one or more electronic devices. Different settings may be provided each electronic device.

After the settings are inputted into the GUI found on the user device, the settings may be transmitted to the respective applicable electronic device (in step 238). The settings can then be used to load the display data provided in step 240. The display data, as described above, may be provided by the user or obtained from one or more social media networks (in step 218). Based on the received user input for the settings obtained from the GUI (in step 238), the display of the display data on one or more applicable is performed accordingly (via step 242).

Upon receiving user inputs relating to settings for the display (via step 220), the display controller software may also inform the user of any available upgrades that can be downloaded and installed from the upgrades marketplace 224. The display controller software may be capable of evaluating information regarding a particular display for a corresponding electronic device and any available settings that can be used for that display. By comparing the evaluated information regarding the electronic device with information in the upgrades marketplace 224 (i.e. available functionalities or upgrades), the display controller software can identify whether the user has the most up-to-date data usable with the electronic device. In situations where upgrades are available, the display controller software can indicate that one or more upgrades (e.g., additional functionalities, applications) are available for download and installation. The display controller software can also indicate a price associated with one or more upgrades, if applicable (see, step 222).

If one or more upgrades are available from the upgrades marketplace 224, the upgrades may be viewable within a gallery of upgrades 226 associated with the upgrades marketplace 224. The gallery 226 may include any available upgrade associated with the upgrades marketplace 224. The gallery 226, therefore, may include functionalities that can single out the one or more applicable upgrades that the user maybe interested in downloading. The gallery 226 may include information regarding the upgrade that can be viewed by the user. The information can be used, for example, by the user to inform whether the upgrade is appropriate to download. For example, such information may include version number, compatibility information, price, and summary of features.

Once one or more upgrades have been selected, the selection can be confirmed through the use of the payment processor 228. In most cases, the payment processor 228 will be used by the upgrades marketplace 224 in order to obtain payment for one or more upgrades. The payment may be performed, for example, by the user inputting credit card information that facilitates the purchase transaction between the user and the upgrades marketplace 224. In an embodiment where one or more selected upgrades from the upgrades marketplace 224 is free (i.e. do not require any payment), the payment processor 228 may not be necessary. The payment processor 228, however, may still be usable to finalize the transaction if the payment processor 228 utilizes account user information associated with the user. For example, a “purchase history” may be associated with the payment processor 228 that record what upgrades were selected and downloaded from the upgrades marketplace 224.

Once the purchase transaction has been completed by the payment processor 228, the upgrades marketplace 224 identifies the user selected upgrade(s) stored in the display control upgrades database 230 associated with the upgrades marketplace 224. The user can then download the selected upgrade(s) from the database in step 232. The upgrade(s) may be stored in memory of the user device until the user performs installation of the upgrades in step 234. The user can then adjust settings for the display of the display data on one or more electronic devices using the additional functionalities associated with the recently downloaded upgrades (step 236). Based on the selected upgrade settings, the upgrade information related to the display data and the recently downloaded upgrades can be provided to the electronic device (step 238). The display data can then be loaded and subsequently displayed (step 240, 242) using the upgrade-based settings selected.

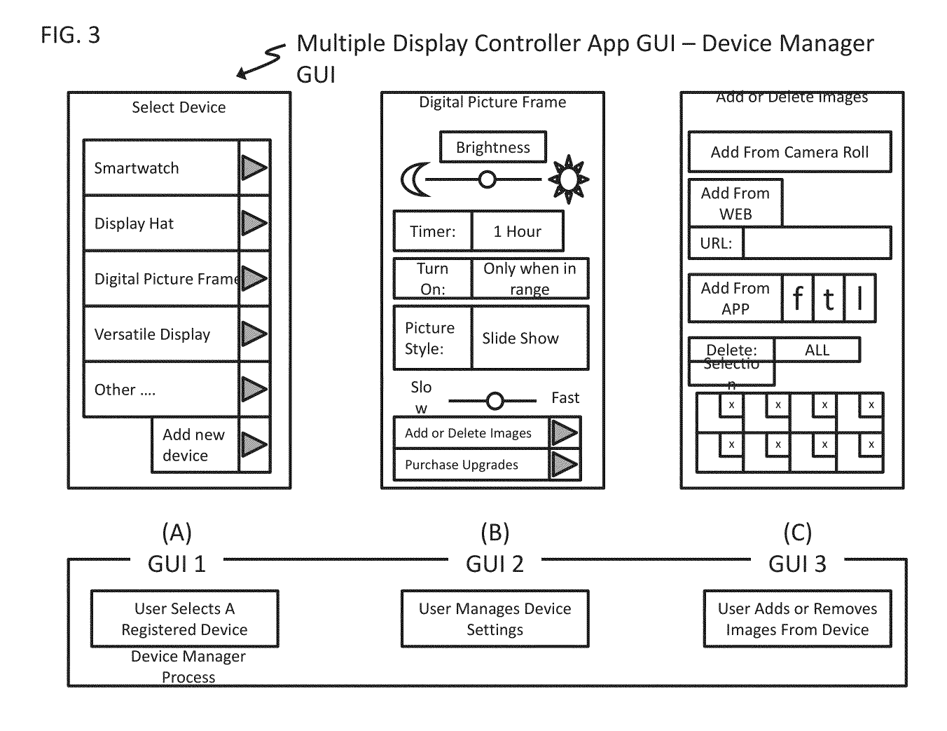

FIG. 3 illustrates the device manager graphical user interface (GUI). As described above, the device manager GUI, the device manager GUI allows users to manage the electronic devices that the user owns using their user device (e.g., smart phone). As illustrated in A), the device manager GUI may allow users to add (i.e. registers), select or remove one or more electronic devices having one or more displays with the user device. For example, the user may associate management of displays associated with their smart watch, hat, digital picture frame or any other versatile display with their user device. Users may also be allowed to add additional electronic devices in the future, for example, corresponding to additional purchases of electronic devices having displays that can be managed via the present invention.

With reference to B), the device manager GUI illustrates an exemplary settings GUI. If the user selects one or more electronic devices registered with the device manager GUI, the GUI may bring up a corresponding settings GUI that facilitates customization of the display of that particular electronic device. In some embodiments, each display and/or each electronic device may have their own separate settings GUI. In some embodiments, the settings GUI may be shared/similar with two or more displays and/or electronic devices.

The settings GUI, illustrated in B), allows the user to customize the various functions of the particular display associated, in this embodiment, the digital picture frame. For example, the user may be capable of adjusting brightness of the display of the digital picture frame, how long the display of the digital picture frame should be activated/turned on for, under what condition the display of the digital picture frame should be activated/turned on, what format the display data should be displayed on the display of the digital picture frame or how frequently images associated with the digital data should be changed. The settings GUI may also allow the user to upload or delete the digital data to be displayed with the corresponding display. Further details regarding this feature is described with reference to C) below.

If upgrades are available, the settings GUI may also include an option that informs the user that upgrades can be downloaded. Upon selection of the upgrades option, the user may be provided a list of one or more available upgrades that can be selected and downloaded in order to supplement further settings functionalities for the electronic device. If the upgrades require payment before download, the settings GUI may also provide this information to the user. For example, in one embodiment, upgrades may be used to adjust the colorization of the display data. (e.g., features directed at converting a color image to a black and white-based image).

As described above, the add or delete images GUI (see C), allows a user to add or delete images (i.e. display data) that may be displayed on one or more displays of the electronic devices. The user may be allowed to upload images, for example, from the camera roll of the user device (e.g., smartphone). The GUI may also allow users to obtain display data from their social media account. With respect to social media-based display data, the user may be instructed to provide a website (i.e. URL) associated with their account so that the display data can be downloaded from the cloud or Internet to the user device (e.g. smart phone).

The user may also be capable of viewing all the uploaded images and determine which display data can be kept and which display data can be deleted. In an embodiment of the present invention, the uploaded images may be viewable as part of a grid. The grid may include thumbnails of each image that is currently being stored on the user device (e.g., smart phone) and subject to be displayed on one or more electronic devices. The add or delete images GUI (see C) can provide features that allows the user to select in order to indicate that a particular image should be deleted from memory (i.e. should not be displayed).

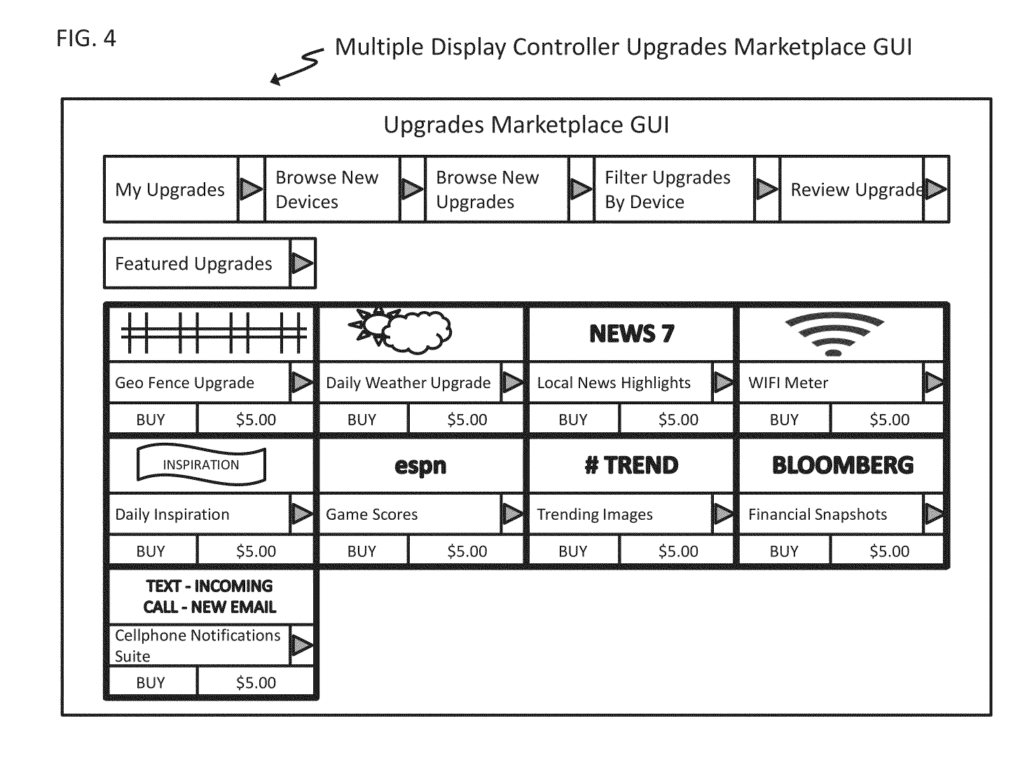

FIG. 4 illustrates the upgrades marketplace graphical user interface. As described above, the upgrades marketplace GUI allows user to view, select and download one or more upgrades through the use of their user device (e.g., smart phone). It should be noted that upgrades, as referred to within the present disclosure, may refer to additional informational updates or applications that can be downloaded and stored within the user device (e.g., smart phone). The informational update or application is used by the user device (e.g., via an application) that improves or expands on a functionality of one or more displays associated with one or more electronic devices registered with the user device.

The upgrades marketplace GUI may contain a number of options that the user can interact with on their user device. The ‘my upgrades’ options may be included to facilitate the user to track what upgrades have already been purchased, downloaded and/or installed on their user device. In situations where the user possesses numerous electronic devices that each have their own respective upgrades, the ‘my upgrades’ option allows the user to better track what upgrades are already in use.

The ‘browse new devices’ allows users to view new available devices. More specifically, the user can view more electronic devices usable with the multiple display controller network that the user can purchase. These additional electronic devices may be organized, for example, by vendor (e.g., Best Buy). In some embodiments, the additional electronic devices may be organized by what upgrades can be used. For example, if a user selects a particular upgrade (e.g., application), the ‘browse new devices’ may provide a list of electronic devices that are compatible with the selected upgrade. In this way, the user may be interested in purchasing one of the listed electronic devices so that the purchased electronic device is compatible with the selected upgrade.

The ‘browse new upgrades’ option may be selected to display, for example, the newest or most recently added upgrades to the upgrades marketplace. In this way, the user can view the most up-to-date upgrade. This information may be helpful in informing the user if the user wishes to purchase an electronic device that is compatible with one of the up-to-date upgrades.

The user may also be capable of filtering the plurality of available upgrades associated with the upgrades marketplace. Via the ‘filter upgrades by device’ option, the user can view selected upgrades based on a particular electronic device. In one embodiment, users can view what upgrades are available for currently owned electronic devices. In other embodiments, the information from the filtered search can inform the user what types of electronic devices should be purchases based on the available up-to-date upgrades. It may also be possible to filter upgrades associated with the upgrades marketplace using other criteria as well. For example, the upgrades may be filtered based on, for example developer, functionality and price. In some embodiments, the criteria for the filtered search may be selectable from a list. In other embodiments, the criteria for the filtered search may be provided via a user input.

The user may also be capable of viewing reviews of one or more selected upgrades associated with the upgrades marketplace. The review may be displayed on the user device (e.g., smart phone) and informs the user of one or more other customer comments regarding the upgrade. Any positive or negative remarks may be included in the reviews so that the user can utilize the remarks to inform whether the upgrade should be purchased and/or downloaded. For example, positive reviews of the upgrade by one or more previous customers may influence the user to purchase and/or download the upgrade.

The upgrades marketplace GUI may also display some ‘featured upgrades’ below the options described above. The ‘featured upgrades’ may be some exemplary upgrades available in the upgrades marketplace. The particular upgrades displayed under the ‘featured upgrades’ may vary over a period of time and may correspond with a particular special occasion (e.g., price reduction/sale). The upgrades illustrated in the ‘featured upgrades’ section may include options that allows users to select and purchase a particular upgrade. Once selected and paid for, the user can download and utilize the ‘featured upgrade’ in a similar manner as any other upgrade that is available in the upgrades marketplace.

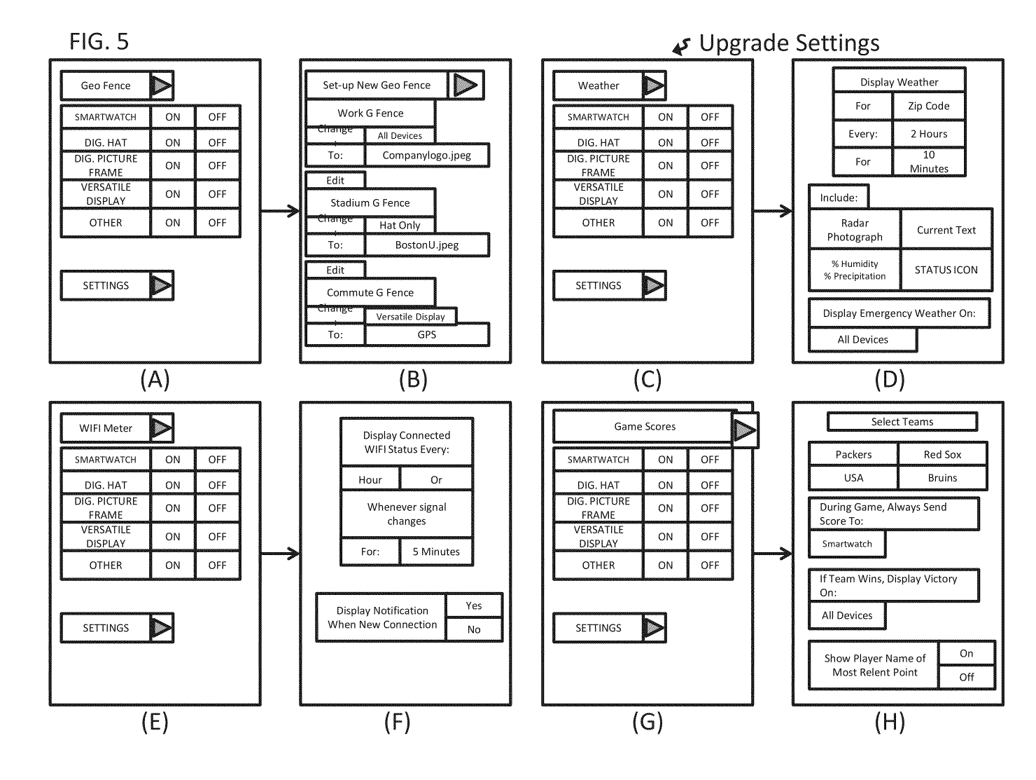

FIG. 5 illustrates further detailed graphical user interfaces of some exemplary upgrades included in the upgrades marketplace. More specifically, A and B illustrates an exemplary geo-fence upgrade, C and D illustrates an exemplary weather upgrade, E and F illustrate an exemplary WiFi upgrade and G and H illustrate an exemplary sports upgrade. With each of the exemplary upgrades, a user can select which electronic device can utilize the particular upgrade. For example, a user can choose to allow the geo-fence upgrade to be usable with one or more electronic devices while disabling the same geo-fence upgrade from being used with other electronic devices. Further details about each exemplary upgrade are provided below.

With reference to the geo-fence upgrade (see A and B), the upgrade can be used to dictate what images can be displayed on corresponding electronic devices based on the position of the user. For example, if the user is detected as being at a stadium, an image displayed on selected electronic devices (e.g., hats) could be changed to represent a sports logo. Subsequently if the user is detected as being at work, an image displayed on the selected electronic devices could correspond with the company logo. The geo-fence upgrade can also be usable to display user location (e.g., GPS) that can be usable, for example, during a daily commute to work.

With reference to the weather upgrade, the feature can allow the user to customize what type of weather-based information is displayed on one or more displays associated with the various electronic devices. The weather upgrade GUI may include user input to specify a zip code identifying the city/area of interest. Other features may be used to identify how frequently the weather-based data should be displayed and/or how often the weather-based data should be updated. A user can also identify what types of weather-based data can be displayed (e.g., humidity, % precipitation probability, current weather status). In some embodiments, the weather upgrade may automatically display emergency weather information (e.g., natural disasters) on all available electronic devices associated with the user device regardless of the user settings.

With reference to E and F, an exemplary wi-fi upgrade is shown. The wi-fi upgrade can provide a feature that evaluates strength of wi-fi signals in the immediate area. The wi-fi signal strength may be indicated using one or more bars as known in the art. Other types of information may also be provided using the wi-fi upgrade including displaying notifications when a new connection is available or when a new connection (e.g., someone is connecting to the wi-fi network) is being initiated. The wi-fi upgrade may also allow the user to customize how often the information regarding the wi-fi connections can be displayed or how often the wi-fi information is updated.

With reference to G and H, an exemplary sports upgrade is shown. Users, via the sports upgrade, can select one or more teams whose sports-based information can be collected and displayed. In an embodiment, the sports upgrade can collect game-based information for corresponding sports team when a live game involving one of the selected teams occurs. The game-based information can then be displayed on one or more displays as indicated by the user. A feature can also allow the user to provide notification on one or more displays when one of the selected teams wins their game.

The sports upgrade can also allow the user to display names of one or more players who, for example, scored recently or have scored the most within a game. Statistics associated with a displayed name can also be included to be displayed.

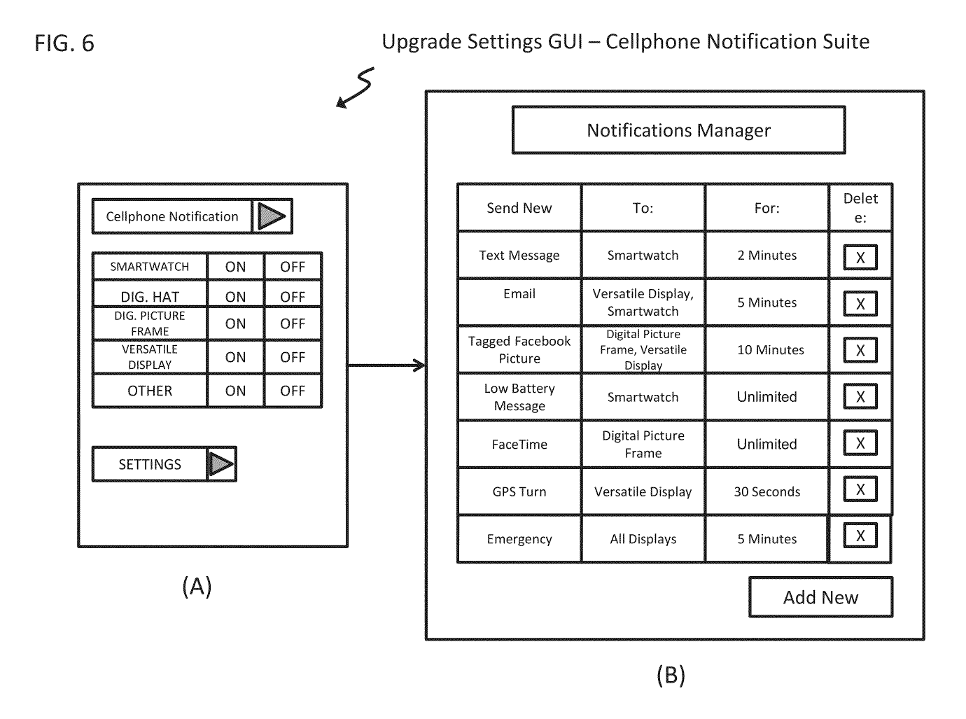

FIG. 6 illustrates a cellphone notification upgrade GUI. The exemplary upgrade illustrated in the figure allows a user to dictate which electronic devices would display cellphone related data (e.g., text messages, emails). With reference to A), the user can select and/or deselect (i.e. turn on or off) the ability for one or more electronic devices to receive the cellphone notifications.

The cellphone notification upgrade GUI also allows the user (via the settings option) to customize the settings for the various different cellphone notifications. With reference to B), the settings include a list of available cellphone notifications (e.g., text message, email, tagged photos, low battery message, video chat, GPS and emergency). Other types of cellphone notifications may also be included in the settings outside of the examples illustrated in FIG. 6. The user can provide the additional types of cellphone notifications via the ‘add new’ option. In some cases, the user can also remove one or more cellphone notifications from being displayed by interacting with the ‘delete’ option associated with each type of cellphone notification listed in the notification manager.

The user, via the cellphone notification setting GUI, can also view which one or more electronic devices each of the cellphone notification will be provided to. In an embodiment, the user may be capable of customizing within the settings which cellphone notifications are pushed to which electronic device displays. For example, as illustrated in FIG. 6, the user can chose to provide text messages to the user smart watch display while e-mails can be provided to both the smart watch display and a versatile display. In some situations, for example emergencies, the user may indicate that the corresponding notification should be provided to all available electronic device displays.

The user may also be capable of indicating how long each type of cellphone notification should be displayed for on the corresponding electronic device displays. For example, the user may want text messages to be forwarded to smart watches and be displayed for two minutes before being removed from the display of the smart watch. Other types of cellphone notifications (e.g., low battery messages) may be allowed to be displayed for longer periods of time.

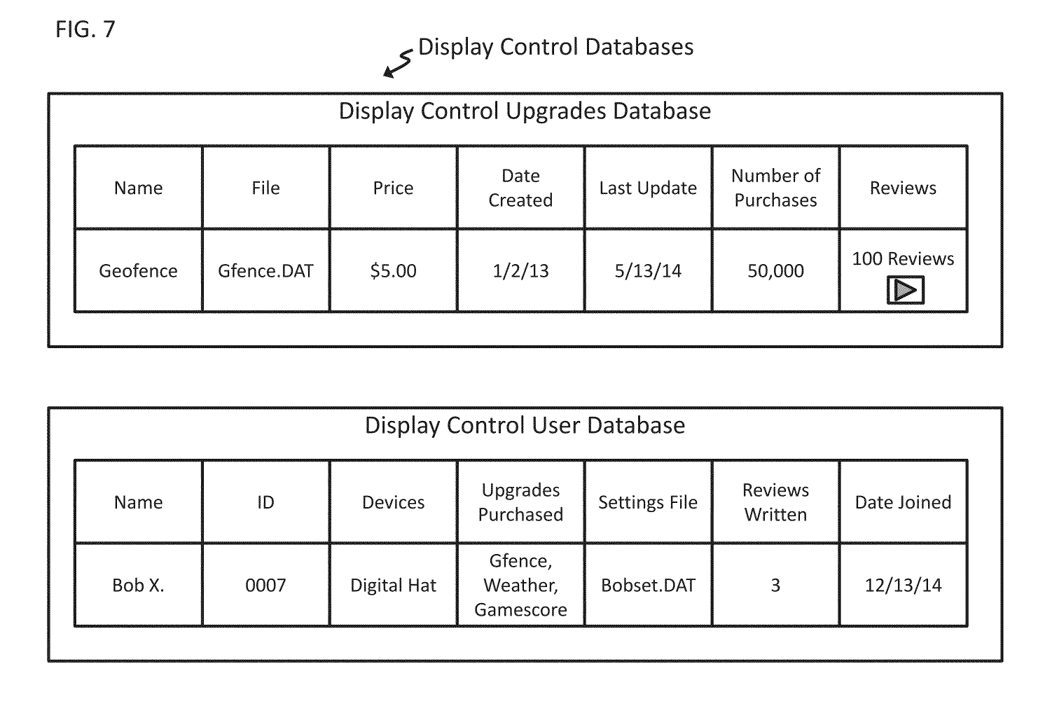

FIG. 7 illustrates display control databases. The display control database may be stored in memory associated with the upgrades marketplace. The display control databases may include a database that lists all the possible upgrades available for download from the upgrades marketplace. The display control databases may also include information about each user (i.e. account-user information) that interacts with the upgrades marketplace.

With reference to the display control upgrade database, the database may include information about each upgrade that can be found on the upgrades marketplace. FIG. 7 illustrates an exemplary entry for a geofence upgrade that the user can purchase and download. It should be noted that other upgrades may also be listed in the display control upgrades database. Each entry associated with a particular upgrade may contain information about the upgrade. As illustrated in the figure, exemplary information may include the name of the upgrade, the file name, the purchase price, the date when the upgrade was created, the date when the upgrade was last updated, a current number of purchases and any available reviews provided from other users who previously purchased, downloaded and used the upgrade.

The display control user database contains information about each user that may have interacted with the user upgrades marketplace. In some embodiments, a user may need to create a user account before the user can view, purchase and download one or more upgrades from the upgrades marketplace. Each user account can be stored in the display control user database. Information that can be stored in a particular entry for a user can include, for example, a unique identification number, registered electronic devices (with corresponding displays) that the user owns and/or uses, a list of upgrades that were previously purchased by the user, any stored user display-based settings, number of reviews (and in some embodiments the actual reviews that were written) of one or more electronic devices or upgrades and when the user first created the user account for the upgrades marketplace.

It should be noted that the information illustrated in the display control upgrades database and the display control user database of FIG. 7 are exemplary in nature. More or less information can be used based on the individual needs of the upgrades market implementing an embodiment of the present invention. For example, the display control user database may want to store credit card information to help facilitate future purchases of upgrades from the upgrades marketplace. Furthermore, the display control upgrades database may include, for example, a text file that includes instructions explaining how the particular upgrade operates. These additional features, though not explicitly illustrated in the figures, would be within the teachings of the present invention as being the sort of additional features that could be implemented.

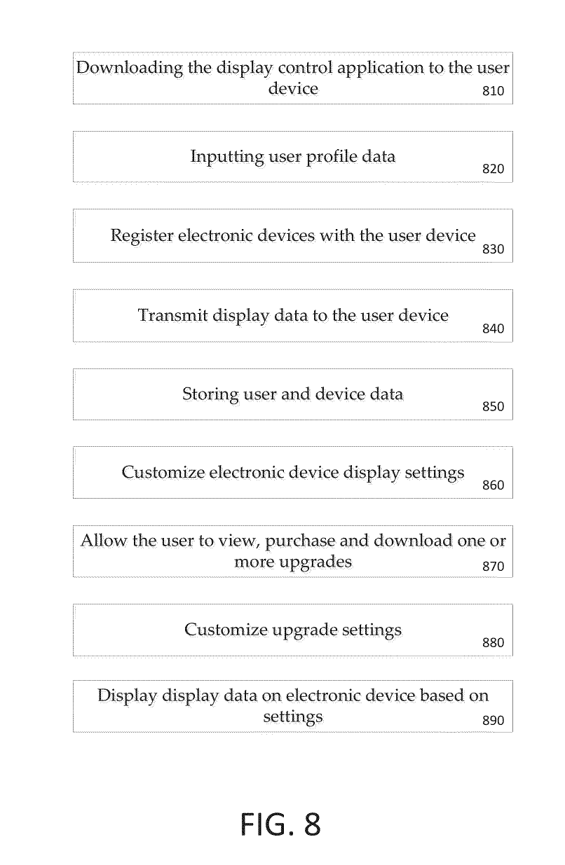

FIG. 8 illustrates a method 800 for operating the multiple display device controller system. The multiple display device controller system is directed at allowing users to control what types of information and how the information is displayed on one or more displays. The users can dictate settings associated with one or more electronic device displays to customize what types of data is displayed on a particular electronic device display and how the data is displayed. Furthermore, the method 800 also allows users to download one or more upgrades so that the functionality of one or more electronic device displays can be improved when possible.

In step 810, the user downloads a display control application onto the user device (e.g., smartphone). The display control application may be downloaded from the display controller network or from an application store. Once downloaded, the user may install the application to operate on the user device. The user device provides a way for the user to control one or more electronic device displays. For example, through one or more graphical user interfaces (GUIs), the user can dictate which electronic device displays are used to display data, what data is to be displayed on which electronic device display and how the data should be displayed.

In step 820, the user inputs user profile data into the user device. The user profile data can be provided to the display controller network when creating a user profile to be used with the upgrade marketplace. The user profile may include information about the user and any corresponding electronic devices and/or upgrades that are currently being used. The user profile data may be referenced by the upgrade marketplace, for example, to track what types of upgrades the user may be interested in based on, for example, the electronic devices associated with the user or what upgrades have been purchased in the past.

In step 830, the user registers one or more electronic devices with the user device. As noted above, exemplary user devices may include smart phones. Once registered with the user device, the user can utilize the user device to manage display settings for the registered electronic device displays. More specifically, the user can dictate what types of information is displayed on which registered electronic device display. The user can also dictate how the information is displayed by customizing the display settings.

In step 840, the display data is transmitted to the user device. The display data can include information (e.g., images) that will be displayed via one or more electronic device displays. The display data may be obtained from a variety of different sources. For example, the display data may be uploaded by the user. In another embodiment, the display data may include information already stored in the user device (e.g., camera roll). Display data may also be obtained from social media networks (e.g., Facebook, Instagram). Such data may be downloaded from the cloud or Internet. A user may provide, for example, a URL website link that indicates where the display data may be obtained.

In step 850, the information regarding the user (e.g., profile data) and the associated electronic devices are stored, for example, in memory associated with the multiple display controller network (e.g., display control user database). The information may be stored for future reference. In one embodiment, the stored user and device data may be used so that the multiple display controller network can provide notification to the appropriate users regarding upgrades that the user may be interested in for electronic devices that the user currently is using.

In step 860, the user can customize settings for one or more electronic device displays via the user device. As noted above, the user device may include a device management GUI that includes options that allows users to dictate which electronic device displays are used. The type of display data for each electronic device display can be specified. The user can also dictate how the display data is displayed.

In step 870, the user can view, purchase and download one or more upgrades from the upgrade marketplace. The user may be informed, for example, by the display controller network of possible upgrades associated with one or more electronic device displays. The upgrades may provide, for example, additional or improved functionalities that affect how the display data is displayed on one or more electronic device displays. The upgrades are associated with an upgrades marketplace that may be generally located in the cloud or Internet. The user may connect with the upgrades marketplace in order to view, purchase and subsequently download one or more upgrades to the user device. Once downloaded, the user may utilize the upgrades with the user device.

In step 880, the user utilizes the downloaded upgrades. The user may further customize the display of the display data based on settings associated with the downloaded upgrades. As noted above, the upgrades may incorporate additional or improved functionalities to the electronic device display. For example, the upgrades may provide additional display features (e.g., color themes, overlays) that were previously not present with the electronic device display originally.

In step 890, the display data is displayed on one or more electronic device displays based on the selected display settings. After the user customizes the display settings (via steps 860 and 880), the display settings along with the display data is transmitted to the corresponding electronic device. The electronic device displays will display the display data (e.g., images) based on the display settings that were transmitted alongside the display data. The electronic device displays will also incorporate any additional functionalities that are dictated by settings associated with the upgrade when the display of the display data is performed.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

It should be noted that the technology can be used in a variety of different events and venues including entertainment or cultural events presented at a theater, gymnasium, stadium or other facility involving a group of people. Such events may also include a variety of sporting events such as football (American and global), baseball, basketball, soccer, ice hockey, lacrosse, rugby, cricket, tennis, track and field, golf, cycling, motor sports such as automobile or motorcycle racing, horse racing, Olympic games, and the like; cultural events such as concerts, music festivals, plays, or the opera, and the like; religious events; and more permanent exhibitions such as museums or historic homes.

What is claimed is:

1. A method for managing multiple displays associated with one or more electronic devices via a user device; the method comprising:
downloading a display control application onto a user device;
registering one or more electronic devices via the display control application, wherein the registered electronic devices have one or more displays that will be managed via the user device;
transmitting display data to the user device, wherein the display data corresponds to data to be displayed on one or more electronic device displays;
downloading one or more upgrades, wherein the upgrades are associated with an upgrades marketplace;
customizing one or more electronic device display settings via the user device, and
displaying the display data on one or more electronic device displays based on the customized electronic device display settings provided by the user via the user device.

2. The method of claim 1, further comprising receiving notification on the user device of one or more available upgrades corresponding to one or more registered electronic devices that can be downloaded, wherein the upgrades further supplement or improve a functionality of corresponding registered electronic devices.

3. The method of claim 1, wherein the electronic device display settings include settings that affect what types of display data will be displayed on a particular electronic device display.

4. The method of claim 1, wherein the electronic device display settings include settings that affect how the display data will be displayed on a particular electronic device display.

5. The method of claim 1, wherein the user device is a smartphone or tablet.

6. The method of claim 1, wherein the display control application corresponds one or more electronic device.

7. The method of claim 1, wherein the display data includes data that is obtained from one or more social media networks.

8. The method of claim 1, wherein the display data to be displayed further includes data already stored on the user device.

9. The method of claim 8, wherein the display data already stored on the user device includes images associated with a camera roll.

10. A system for managing multiple displays associated with one or more electronic devices via a user device, the system comprising:
a user device, wherein the user device includes a user interface for managing one or more electronic device displays;
a database associated with an upgrades marketplace, wherein the database includes one or more upgrades; and
a processor, the processor executing instructions stored in memory to:
download a display control application onto the user device;
register one or more electronic devices via the display control application, wherein the registered electronic devices have one or more displays that will be managed via the user device;
transmit display data to the user device, wherein the display data corresponds to data to be displayed on one or more electronic device displays;
download one or more upgrades from the database;
customize one or more electronic device display settings via the user device, and
display the display data on one or more electronic device displays based on the customized electronic device display settings provided by the user via the user device.

11. The system of claim 10, wherein the processor further provides notification on the user device of one or more available upgrades corresponding to one or more registered electronic devices that can be downloaded, wherein the upgrades further supplement or improve a functionality of corresponding registered electronic devices.

12. The system of claim 10, wherein the electronic device display settings include settings that affect what types of display data will be displayed on a particular electronic device display.

13. The system of claim 10, wherein the electronic device display settings include settings that affect how the display data will be displayed on a particular electronic device display.

14. The system of claim 10, wherein the user device is a smartphone or tablet.

15. The system of claim 10, wherein the display control application corresponds to one or more electronic device.

16. The system of claim 10, wherein the display data includes data that is obtained from one or more social media networks.

17. The system of claim 10, wherein the display data to be displayed further includes data already stored on the user device.

18. The system of claim 17, wherein the display data already stored on the user device includes images associated with a camera roll.
